(19) United States
(12) Patent Application Publication
(10) Pub. No.: US 2010/0260077 A1
(43) Pub. Date: Oct. 14, 2010

(54) RADIO CIRCUIT DEVICE

(76) Inventors: Toshifumi Nakatani, (US); Satoshi Tsukamoto, Osaka (JP); Noriaki Saito, Tokyo (JP)

Correspondence Address: WENDEROTH, LIND & PONACK L.L.P., 1030 15th Street, N.W., Suite 400 East, Washington, DC, 20005-1503, US

(21) Appl. No.: 12/747,349

(22) PCT Filed: Dec. 9, 2008
(86) PCT No.: PCT/JP2008/003679

§ 371 Date: Jun. 10, 2010

(30) Foreign Application Priority Data
Dec. 12, 2007 (JP) 2007-320905
Dec. 8, 2008 (JP) 2008-312371

(51) Int. Cl. H04B 1/44

(52) U.S. Cl. 370/278

(57) ABSTRACT

A radio circuit device capable of reducing a cross-modulation interference which occurs at a reception circuit due to a transmission signal leakage is provided.

A transmission baseband circuit (12) for outputting a transmission signal, a reception circuit (14, 15) for receiving a reception signal as differential RF signals, an envelope signal generation circuit (24) for generating, from the transmission signal (12) outputted by the transmission baseband circuit, an envelope signal derived from a square of an envelope signal of the RF transmission signal, an envelope signal control circuit (20) for outputting a control signal to control an amplitude and a delay time of the envelope signal, and an envelope signal injection circuit (23) for controlling the amplitude and the delay time of the envelope signal in accordance with the control signal outputted from the envelope signal control circuit (20) and for injecting in phase the controlled envelope signal into each of the differential RF signals in the reception circuit (14, 15), are provided.

### TECHNICAL FIELD

The present invention relates to a radio circuit device which reduces a cross-modulation interference that occurs at a reception circuit due to a transmission signal leakage.

### BACKGROUND ART

High speed transmission for a mobile telephone is increasingly demanded year by year. In order to meet the demand, a simultaneous transmission and reception system has been used for a third-generation mobile telephone.

FIG. 11 illustrates examples of a UMTS wireless device, which is one kind of the third-generation mobile telephone, and a jamming occurring at the UMTS wireless device. In a test scenario under the 3GPP standard, a case where a GSM jammer signal having a frequency near a frequency of a UMTS desired signal is received (Narrow Band Blocking, Narrow Band Intermodulation, (a) of FIG. 11) is assumed. On the other hand, in the simultaneous transmission and reception, a part of a transmission signal is inputted to a low-noise amplifier (LNA) 134 via a duplexer 133. At this time, due to nonlinearity represented by the LNA 134, cross-modulation occurs between the GSM jammer signal and an envelope of a leaked transmission signal ((b) of FIG. 11). A frequency band in which noise caused by the cross-modulation appears is close to a frequency band of a UMTS desired signal, which is a cause of degrading receiving sensitivity.

In general, like the UMTS wireless device illustrated in FIG. 11, a filter 135 is provided between the LNA 134 and a down mixer 136, so that the above-described jamming occurring at the down mixer 136 is sufficiently small. However, for further downsizing and cost reduction of the device, the filter 135 must be eliminated in the future. In the UMTS wireless device which does not have the filter 135, since a jammer signal amplified by the LNA 134 is transmitted as it is, a cross-modulation interference occurring at the down mixer 136 as described above is large. Accordingly, technology for reduction of the cross-modulation interference is essential.

FIG. 12 illustrates a configuration of a conventional radio circuit device which reduces the cross-modulation interference (see Patent Literature 1). The conventional radio circuit device illustrated in FIG. 12 has a configuration in which a transmission circuit 141 and a reception circuit 142 are connected to an antenna 140 via a duplexer 143 to share the antenna 140 for transmission of a transmission signal from the transmission circuit 141 and for reception of a reception signal by the reception circuit 142. Further, the conventional radio circuit device illustrated in FIG. 12 includes a cancel signal generation section 144 for generating a cancel signal which is anti-phase with respect to the transmission signal transmitted from the transmission circuit 141. In the conventional radio circuit device, the cancel signal outputted from the cancel signal generation section 144 is synthesized by a power synthesis section 145 with a reception signal inputted to the reception circuit 142 so as to cancel the transmission signal which is leaked from the transmission circuit 141 via the duplexer 143 to the reception signal inputted to the reception circuit 142, so that saturation at the low-noise amplifier 146 is avoided.

Further, FIG. 13 illustrates a configuration of another conventional radio circuit device which reduces the cross-modulation interference (see Patent Literature 2). The conventional radio circuit device (transmitting and receiving apparatus) 150 illustrated in FIG. 13 includes: a baseband unit 151 for outputting a baseband signal; a modulation unit 152 for modulating the baseband signal and outputting the modulated signal: a transmission amplifier 154 for amplifying the modulated signal and outputting a transmission signal to a duplexer 153; and a reception amplifier 155 for receiving a reception signal from the duplexer 153 as well as having a gain modulated by an envelope signal which is proportional to the transmission signal. Here, a jamming object 156 is an AMPS type telephone interfering with or jamming a Code Division Multiple Access (CDMA) telephone having the radio circuit device 150, and the jamming object 156 is a source of a jammer signal 157. In the radio circuit device 150 illustrated in FIG. 13, the baseband unit 151 changes the gain of the reception amplifier 155 in proportion to the square of the envelope of the transmission signal in order to reduce the cross-modulation.

Still further, FIG. 14 illustrates a configuration of another conventional radio circuit device which reduces the cross-modulation interference (see Patent Literature 3). The conventional radio circuit device (radio transceiver) illustrated in FIG. 14 has a transmission signal path 160 and a reception signal path 161, and the paths 160 and 161 are connected to an antenna 163 via a duplexer 162. Here, an amplifier 164 included in the reception signal path 161 modulates a jammer signal which is not amplitude-modulated (or further modulates an already amplitude modulated jammer signal) in the reception path by using an amplitude modulated transmission signal or another bleed over signal in the reception path. In order to reduce this cross-modulation interference, it is necessary to consider nonlinearity represented by the amplifier 164.

Accordingly, the conventional radio circuit device illustrated in FIG. 14 redirects a reception signal 165 to a linearization circuit 166, and outputs a conditioned signal 167 to the amplifier 164. The linearization circuit 166 detects a part of a transmission signal 168, extracts an envelope signal, and produces, from the envelope signal, a dummy modulated signal having a frequency different from frequencies of the transmission signal and the reception signal. Specifically, the amplifier 164 is forced to cause a sum of the square of the envelope signal and the square of an envelope of the dummy signal to be constant, and synthesize the dummy signal with the reception signal 165, thereby performing amplification in a linear manner with respect to the jammer signal. A filter 169 cancels, from an output of the amplifier 164, the dummy signal, the bleed-over signal, the jammer signal, and a signal having a bandwidth of any intermodulation products generated by filtering the dummy signal in order to reduce the cross-modulation interference.
Patent Literature 1: Japanese Laid-Open Patent Publication No. 11-308143
Patent Literature 2: Japanese Laid-Open Patent Publication No. 2000-349678
Patent Literature 3: Japanese Translation of PCT International Publication No. 2005-531991

### DISCLOSURE OF THE INVENTION

### Problems to be Solved by the Invention

However, in the conventional radio circuit device disclosed in Patent Literature 1, the cancel signal which is anti-phase with respect to the transmission signal is injected into an input to the reception circuit 142. At this time, not only the injected cancel signal but also noise of a reception band frequency which occurs at the power synthesis section 145 is inputted. Consequently, the noise degrades receiving sensitivity. However, since the frequency of the cancel signal and that of the reception signal are approximately equal to each other, it is difficult to reduce the noise without using an external filter having a high Q value.

Further, the conventional radio circuit device 150 disclosed in Patent Literature 2 can reduce the cross-modulation by using the envelope of the transmission signal. However, the reception signal and the transmission signal have the same bandwidth. Accordingly, when the gain of the reception amplifier 155 is modulated by the envelope of the transmission signal, the envelope of the transmission signal is superimposed on the modulated reception signal. Further, a third-order nonlinear coefficient of the reception amplifier 155 varies in accordance with variation of the gain. Consequently, new jamming occurs and degrades receiving sensitivity.

Still further, in the conventional radio circuit device disclosed in Patent Literature 3, the cross-modulation interference can be reduced by injecting into the input to the reception signal path 161 the dummy signal having the envelope which is anti-phase with respect to the envelope of the transmission signal 168. However, the filter 169 is additionally required to suppress the injected dummy signal. This contradicts an intended object to achieve a filterless circuit. Further, the linearization circuit 166 is provided at the input to the reception signal path 161, and thereby noise occurring at the linearization circuit 166 degrades receiving sensitivity.

Therefore, an object of the present invention is to provide a radio circuit device which overcomes the above-described problems of the conventional art as well as reduces a cross-modulation interference which occurs at a reception circuit due to a transmission signal leakage.

### Solution to the Problems

The present invention is directed to a radio circuit device including a duplexer for separating between transmission and reception. In order to achieve the above-described object, the radio circuit device of the present invention includes: a transmission baseband circuit for outputting a transmission signal; a reception circuit for receiving a reception signal as differential signals; an envelope signal generation circuit for generating, from the transmission signal outputted by the transmission baseband circuit, an envelope signal derived from a component of a square of an envelope of the transmission signal; an envelope signal control circuit for outputting a control signal to control an amplitude of the envelope signal, and a delay time of the envelope signal with respect to the transmission signal; and an envelope signal injection circuit for correcting, in accordance with the control signal outputted by the envelope signal control circuit, the amplitude and the delay time of the envelope signal, and for injecting in phase the corrected envelope signal into each of the differential signals to be inputted to the reception circuit, to suppress a leaked transmission signal which leaks to the reception circuit via the duplexer.

It is preferable that the envelope signal control circuit controls at least one of the amplitude and the delay time of the envelope signal such that an amplitude of an addition signal obtained by an addition of the leaked transmission signal, which leaks to the reception circuit via the duplexer, and the corrected envelope signal becomes substantially zero.

The radio circuit device may further include a look-up table for storing information indicating a relationship between the amplitude and the delay time of the envelope signal, and the envelop signal control circuit may output the control signal in accordance with the information stored in the look-up table. Further, a digital filter circuit may be further provided, preceding the envelope signal generation circuit, for performing control such that a frequency characteristic of the envelope signal which passes through the digital filter circuit becomes substantially equal to a frequency characteristic of an amplitude of the leaked transmission signal. Furthermore, either a pre-distortion circuit for distorting the envelope signal outputted by the envelope signal injection circuit or a delay time change circuit for adjusting any delay time by changing a combination of delay elements selected from a plurality of delay elements may be further provided between the envelope signal control circuit and the reception circuit.

Here, when the look-up table stores the information indicating the relationship between the amplitude and the delay time of the envelope signal for each transmission frequency, the envelope signal control circuit may output the control signal in accordance with a frequency of the transmission signal. When the look-up table stores the information indicating the relationship between the amplitude and the delay time of the envelope signal for each reception frequency, the envelope signal control circuit may output the control signal in accordance with a frequency of the reception signal. Further, when the look-up table stores the information indicating the relationship between the amplitude and the delay time of the envelope signal for each power supply voltage supplied to the radio circuit device, the envelope signal control circuit may output the control signal in accordance with the power supply voltage. When the look-up table stores the information indicating the relationship between the amplitude and the delay time of the envelope signal for each temperature within the radio circuit device, the envelope signal control circuit may output the control signal in accordance with the temperature.

When the reception circuit includes an amplifier for amplifying the differential signals, and a down mixer for converting the differential signals which have been amplified by the amplifier to baseband signals by using locally generated signals, the envelope signal injection circuit preferably injects the corrected envelope signals into inputs, respectively, to the down mixer in the reception circuit or into inputs, respectively, to the amplifier in the reception circuit.

Further, it is preferable that when the transmission baseband circuit outputs a baseband signal modulated by polar modulation, the envelope signal generation circuit generates the envelope signal based on a square of an amplitude modulated signal included in the baseband signal. It is preferable that when the transmission baseband circuit outputs a baseband signal modulated by orthogonal modulation, the envelope signal generation circuit generates the envelope signal based on a sum of a square of an I component signal and a Q component signal of the baseband signal.

### Effect of the Invention

The radio circuit device of the present invention has a configuration in which envelope signals of a transmission signal are injected in phase into a differential reception circuit, and therefore reduces an influence of noise occurring at a signal injection circuit, and does not generate a new jamming at an LNA or the like, thereby reducing a cross-modulation interference caused by a transmission signal leakage.

### BRIEF DESCRIPTION OF THE DRAWINGS

FIG. 1 is a diagram illustrating a configuration of a radio circuit device according to a first embodiment of the present invention.

FIG. 2 illustrates a frequency spectrum of a signal inputted to the radio circuit device according to the first embodiment of the present invention.

FIG. 3 is a diagram illustrating an exemplary equivalent circuit model of an LNA 15.

FIG. 4 is a diagram illustrating an exemplary equivalent circuit model of a down mixer 17.

FIG. 5A illustrates an exemplary theoretical calculation of cross-modulation noise reduction for illustrating an operation of the radio circuit device.

FIG. 5B illustrates an exemplary theoretical calculation of cross-modulation noise reduction for illustrating an operation of the radio circuit device.

FIG. 5C illustrates an exemplary theoretical calculation of cross-modulation noise reduction for illustrating an operation of the radio circuit device.

FIG. 5D illustrates an exemplary theoretical calculation of cross-modulation noise reduction for illustrating an operation of the radio circuit device.

FIG. 6 is a diagram illustrating a configuration of a radio circuit device according to a second embodiment of the present invention.

FIG. 7 is a diagram illustrating a configuration of a radio circuit device according to a third embodiment of the present invention.

FIG. 8 is a diagram illustrating a configuration of a radio circuit device according to a fourth embodiment of the present invention.

FIG. 9 is a diagram illustrating a configuration of a radio circuit device according to a fifth embodiment of the present invention.

FIG. 10 is a diagram illustrating examples of look-up tables 21 and 51.

FIG. 11 is a diagram illustrating an example of jamming occurring at a conventional mobile telephone.

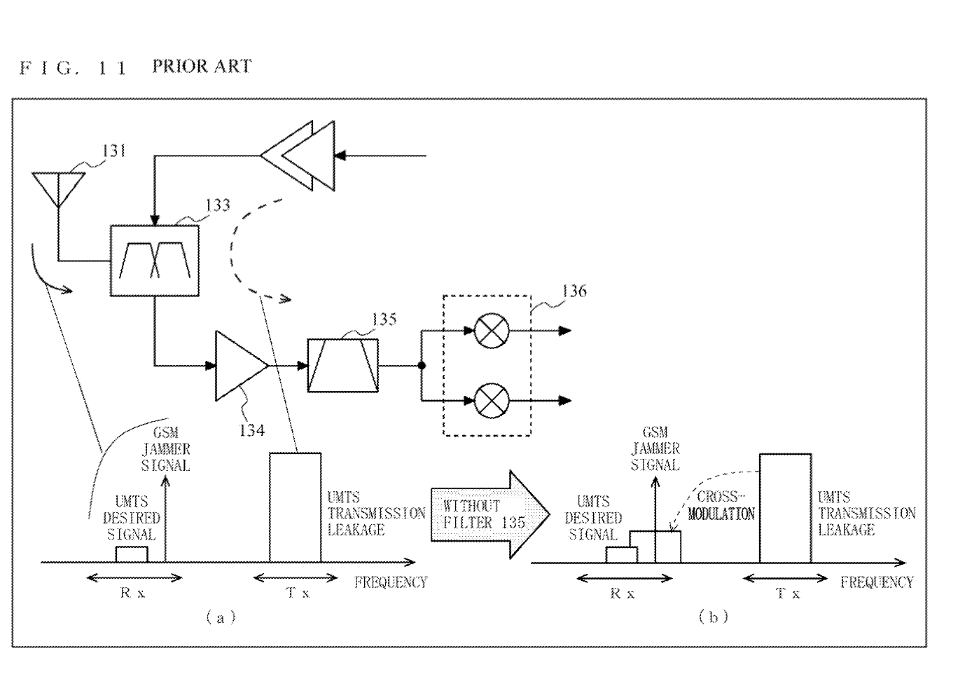

FIG. 12 is a diagram illustrating a configuration of a conventional radio circuit device.

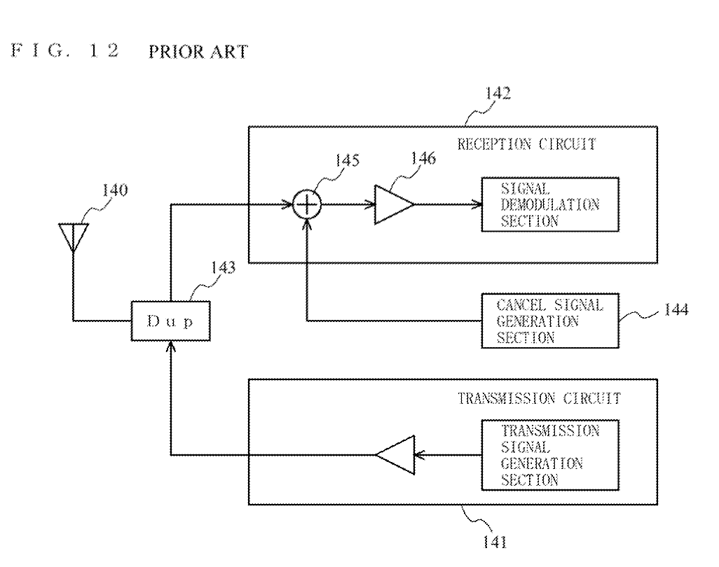

FIG. 13 is a diagram illustrating a configuration of a conventional radio circuit device.

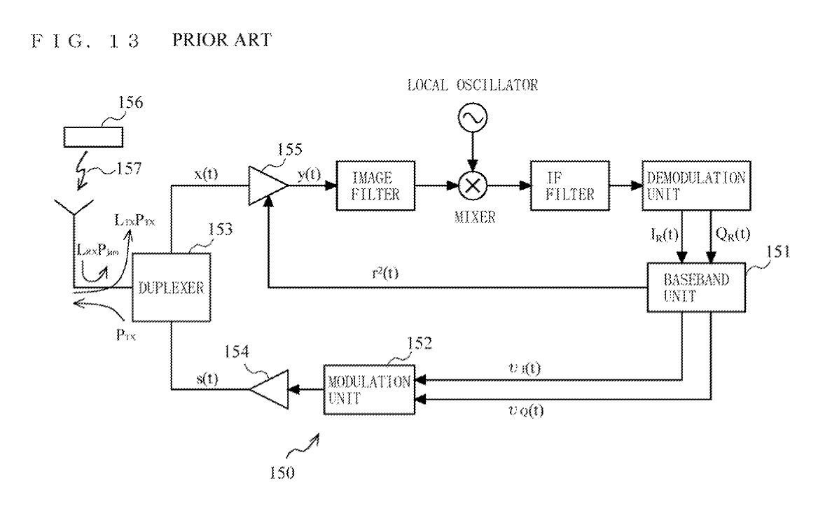

FIG. 14 is a diagram illustrating a configuration of a conventional radio circuit device.

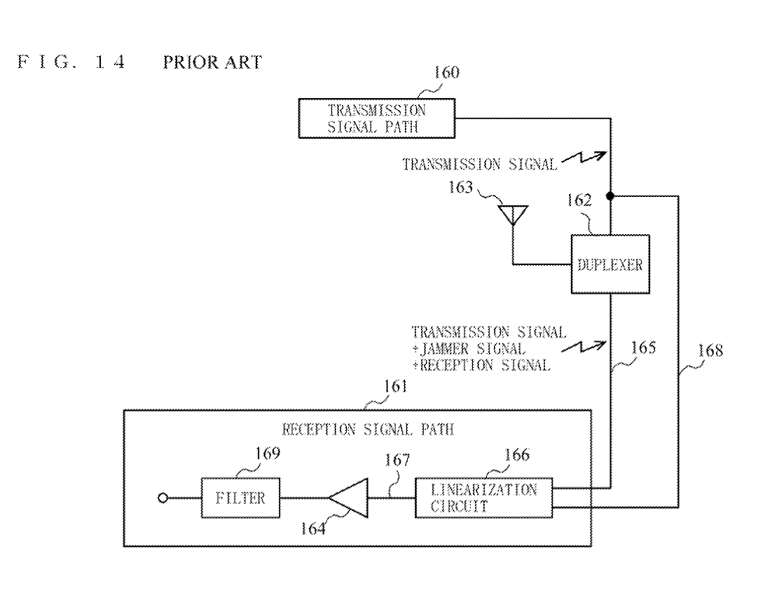

### DESCRIPTION OF THE REFERENCE CHARACTERS

11, 131, 140, 163 antenna

12 transmission baseband circuit

13 transmission RF circuit

14, 133, 143, 153, 162 duplexer

15, 33, 37, 48, 134, 146, 154, 155, 164 amplifier

16, 145 adder

17, 136 down mixer

18 reception baseband circuit

19 frequency control circuit

20 envelope signal control circuit

21, 51 look-up table

22 temperature/voltage detection circuit

23 envelope signal injection circuit

24 envelope signal generation circuit

25, 43 oscillator

32 phase modulator

31 polar modulation circuit

34, 38, 42, 46 DAC

35 envelope signal modulation circuit

36, 44 phase shifter

41 I/Q modulation circuit

45, 47 multiplier

52 variable filter circuit

61 pre-distortion circuit

135, 169 filter

141, 160 transmission circuit

142, 161 reception circuit

144 cancel signal generation section

151 baseband unit

152 modulation unit

156 jamming object

166 linearization circuit

### BEST MODE FOR CARRYING OUT THE INVENTION

### First Embodiment

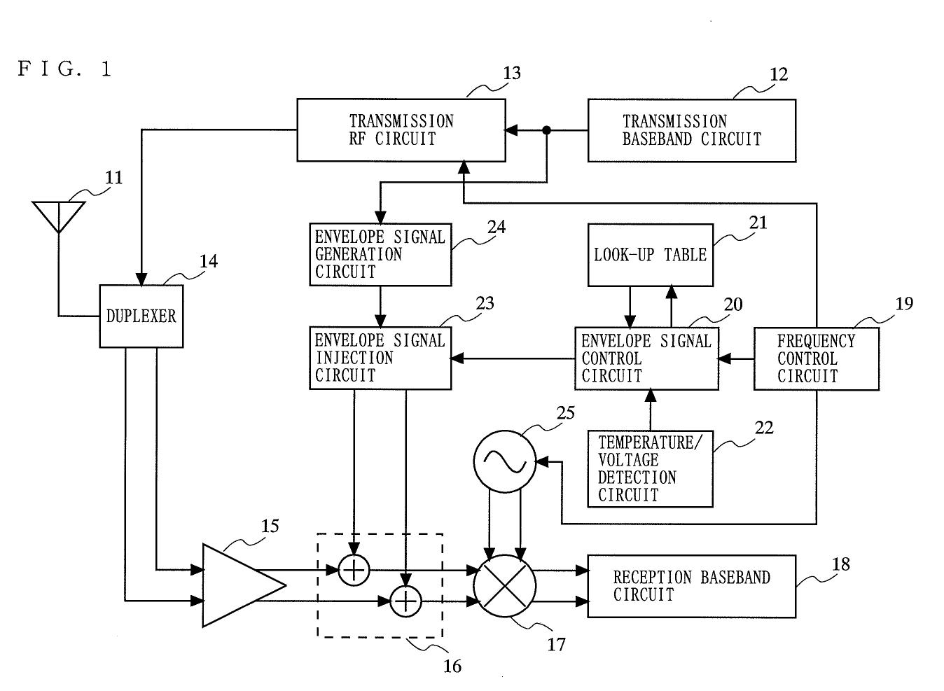

FIG. 1 is a diagram illustrating a configuration of a radio circuit device according to a first embodiment of the present invention. In the radio circuit device according to the first embodiment, a transmission baseband circuit 12 and a transmission RF circuit 13 are connected to an antenna 11 via a duplexer 14. A transmission signal generated by the transmission baseband circuit 12 is converted by the transmission RF circuit 13 to a signal having a transmission frequency (RF) and transmitted from the antenna 11. The antenna 11, the duplexer 14, the transmission baseband circuit 12, and the transmission RF circuit 13 form a transmission circuit.

A reception signal received by the antenna 11 is converted to differential signals by the duplexer 14, and the differential signals are amplified by an LNA 15. The differential signals amplified by the LNA 15 are converted by a down mixer 17 to baseband signals by using locally generated signals which have been generated by an oscillator 25, and the baseband signals are inputted to a reception baseband circuit 18. The antenna 11, the duplexer 14, the LNA 15, adders 16, the oscillator 25, the down mixer 17, and the reception baseband circuit 18 form a reception circuit.

In respective embodiments of the present invention, the reception signal received by the antenna 11 is differentially converted by the duplexer 14, but the reception signal may be differentially converted by the LNA 15 connected to the duplexer 14 in a single-ended manner.

A frequency control circuit 19 obtains, from channel information of a PLL circuit not shown in FIG. 1, information of a frequency of the transmission signal and a frequency of the reception signal, and controls the transmission RF circuit 13 and the oscillator 25. As will be described later in detail, the frequency control circuit 19 outputs a control signal to an envelope signal control circuit 20, and an envelope signal injection circuit 23 controls at least one of an amplitude of each of envelope signals to be injected into the differential signals, respectively, outputted by the LNA 15 and a delay time (phase), with respect to the transmission signal, of each of the envelope signals.

Next, a mechanism for the cross-modulation suppression performed by the radio circuit device according to the first embodiment is described.

A desired signal and a GSM jammer signal which are received via the antenna 11 and the duplexer 14, and a leaked transmission signal are amplified by the LNA 15, and converted to the baseband signals by the down mixer 17. The envelope signal injection circuit 23 corrects, in accordance with the control signal outputted from the envelope signal control circuit 20, at least one of the amplitude and the delay time of the envelope signal outputted from the envelope signal generation circuit 24. The envelope signal injection circuit 23 injects the corrected envelope signals into inputs, respectively, to the down mixer 17. At the time of injection, the in-phase corrected envelope signals outputted from the envelope signal injection circuit 23 are added by the adders 16 to the differential signals, respectively, outputted from the LNA 15. Alternatively, the in-phase corrected envelope signals outputted from the envelope signal injection circuit 23 may be added to the differential signals, respectively, outputted from the duplexer 14.

The envelope signal generation circuit 24 generates, from a transmission signal outputted from the transmission baseband circuit 12, an envelope signal derived from a component of the square of an envelope of the transmission signal. At this time, the envelope signal control circuit 20 outputs the control signal for controlling the amplitude and the delay time of the injected envelope signals, in accordance with a look-up table 21 in which information indicating a relationship between the amplitude and the delay time of the envelope signal is stored, the frequency of the transmission signal and the frequency of the reception signal which frequencies are indicated by the frequency control circuit 19, and a temperature and a supply voltage of a semiconductor (IC chip) which are detected by the temperature/voltage detection circuit 22.

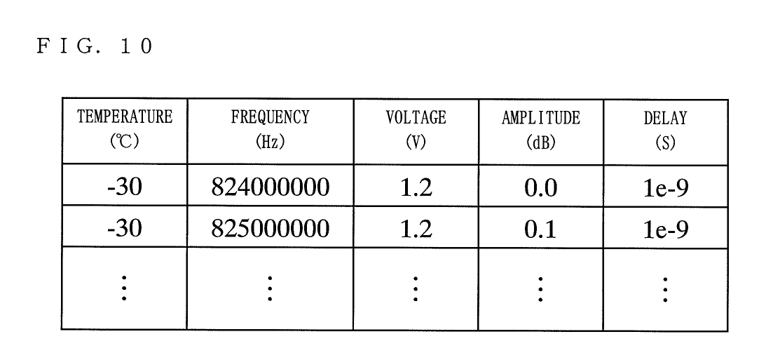

Specifically, the temperature/voltage detection circuit 22 detects the temperature and the supply voltage of the semiconductor (IC chip), and the information indicating the relationship between the amplitude and the delay time of the envelope signal is read from the look-up table 21. Accordingly, the cross-modulation interference can be suppressed regardless of the temperature change in the radio circuit device. For example, in the look-up table 21, as illustrated in FIG. 10, the relationship between the amplitude and the delay time of the envelope signal is stored for each temperature inside the radio circuit device, for each transmission frequency or reception frequency, and for each power supply voltage supplied to the radio circuit device.

Regarding temperature information, although it is preferable that the temperature/voltage detection circuit 22 detects the temperature of the LNA 15 or of the down mixer 17 which is a main cause of the temperature change which may cause the cross-modulation interference, the temperature/voltage detection circuit 22 may detect a temperature of another block in an IC chip other than the LNA 15 and the down mixer 17. Further, regarding the temperature and the supply voltage, by timely setting threshold values for a temperature to be detected and a supply voltage to be detected, respectively, a stepwise control may be performed based on “high temperature/ordinary temperature/low temperature” and “high-power output/ordinary-power output/low-power output”. The temperature can be detected by a temperature sensor such as a thermocouple, a transistor, and the like attached to a portion whose temperature is to be detected.

As described above, both the LNA 15 and the down mixer 17 are differential circuits, and the LNA 15 and the down mixer 17 receive and output differential signals. On the other hand, two envelope signals injected into the down mixer 17 are in-phase signals. Under the 3GPP standard, a case is assumed where an envelope component of the transmission signal is superimposed on the GSM jammer signal in a frequency band close to that of the transmission signal due to the cross-modulation. The radio circuit device according to the present embodiment is capable of causing, by controlling at least one of the amplitude and the delay time of the envelope signal to be injected, cross-modulation noise and an up-converted signal to cancel each other. Note that, since the two envelope signals to be injected are the in-phase signals, the two envelope signals can be easily eliminated by a common mode rejection circuit such as a common mode feedback circuit or the like.

Hereinafter, the mechanism for suppressing the cross-modulation is described in more detail by using mathematical formulas.

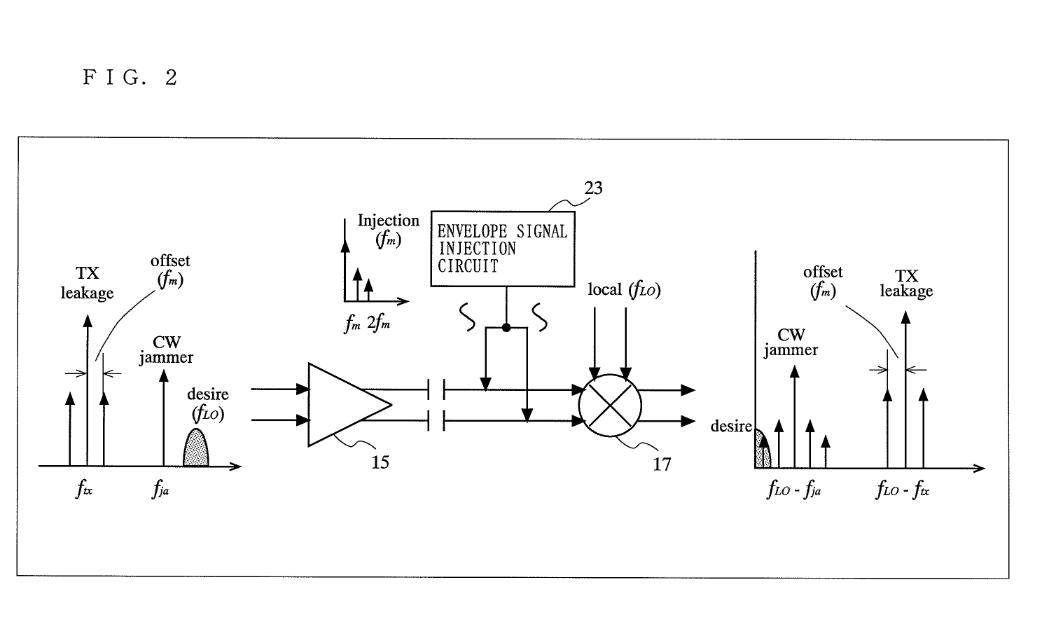

FIG. 2 illustrates a frequency spectrum of a signal to be inputted. For simplicity, it is assumed that the transmission signal is an AM modulated signal. It is assumed that signals inputted to the LNA 15 are a desired signal (desire), a CW jammer signal (jammer), and a leaked transmission signal (TX leakage) having leaked to the reception circuit. In this case, due to nonlinearity represented by the LNA 15 and the down mixer 17, a component of the square of the envelope of the transmission signal is superimposed, at each output of the down mixer 17, on the CW jammer signal. Hereinafter, when the component of the square of the envelope of the transmission signal is inputted into an input to the down mixer 17 as the in-phase signal, how much a jamming component is suppressed is calculated.

Initially, the LNA 15 is described.

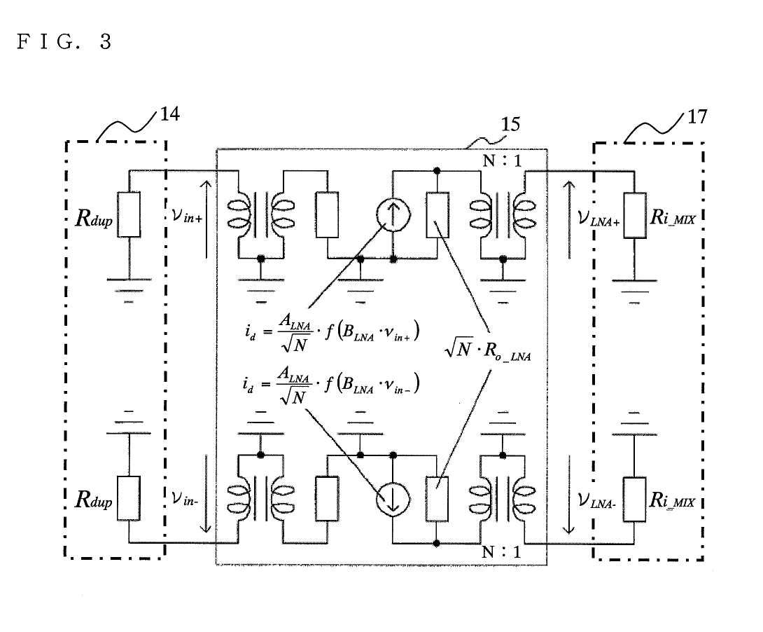

FIG. 3 illustrates an exemplary equivalent circuit model of the LNA 15. It is assumed that the LNA 15 is a differential amplifier. A CW jammer signal voltage vⱼₐ and a transmission signal leakage voltage v_{b}, (single side) which are inputted from the duplexer 14 are represented as [Math. 1]. Here, it is assumed that a transmission signal frequency is fₜₓ, a CW jammer signal frequency is fⱼₐ, and a modulated wave frequency is fₘ, fₘ<<fₜₓ<fⱼₐ is satisfied. Further, Aⱼₐ and Aₜₓ are constants.

vⱼₐ=Aⱼₐ·cos(2πfⱼₐ·t)

vₜₓ=Aₜₓ·{1+m·cos(2πfₘ·t)}·cos(2πfₜₓ·t) [Math. 1]

Further, an output voltage v′_{LNA} (assuming that an in-phase voltage of the output voltage is v′_{LNA+}, and an anti-phase voltage of the output voltage is v′_{LNA-}) of the LNA 15 is represented as [Math. 2] by using a frequency f_{LNA} of the output signal, an output impedance Rₒ_{_{—}}_{LNA} of the LNA 15, and an input impedance Rᵢ_{_{—}}_{MIX} and an output impedance Rₒ_{_{—}}_{MIX} of the mixer 17. In addition, f_{LNA}(bias+x)=a₁_{_{—LNA}}x+a₂_{_{—}}_{LNA}x²+a₃_{_{—}}_{LNA}x³ (here, a₁_{_{—}}_{LNA}, a₂_{_{—}}_{LNA}, and a₃_{_{—}}_{LNA} are constants) is satisfied. Further, A_{LNA} and B_{LNA} are constants. Still further, bias represents a bias voltage of the LNA 15.

in-phase: v′_{LNA+}=(Rₒ_{_{—}}_{LNA}//Rᵢ_{_{—}}_{MIX})·A_{LNA}·f_{LNA}{bias+B_{LNA}·(vⱼₐ+vₜₓ)}

anti-phase: v′_{LNA-}=(Rₒ_{_{—}}_{LNA}//Rᵢ_{_{—}}_{MIX})·A_{LNA}·f_{LNA}{bias+B_{LNA}·(−vⱼₐ−vₜₓ)} [Math. 2]

At this time, cut of DC of the output voltage v′_{LNA} of the LNA 15 is necessary prior to input to the down mixer 17. For simplicity, common mode rejection is used instead thereof. A voltage v_{LNA} inputted to the down mixer 17 is represented as [Math. 3].

in-phase: v_{LNA+}=v′_{LNA+}−v′_{LNA-}

anti-phase: v_{LNA-}=v′_{LNA-}−v′_{LNA+} [Math. 3]

In [Math. 3], the CW jammer signal component vⱼₐ_{_{—}}_{LNA} (assuming that an in-phase component of the CW jammer signal component is vⱼₐ_{_{—}}_{LNA+}, and an anti-phase component of the CW jammer signal component is vⱼₐ_{_{—}}_{LNA-}) outputted by the LNA 15 is calculated, in accordance with (Rₒ_{_{—}}_{LNA}//Rᵢ_{_{—}}_{MIX})A_{LNA}·a₁_{_{—}}_{LNA}·B_{LNA}·vⱼₐ, by using [Math. 4].

in-phase: vⱼₐ_{_{—}}_{LNA+}=(Rₒ_{_{—}}_{LNA}//Rᵢ_{_{—}}_{MIX})·A_{LNA}·a₁_{_{—}}_{LNA}·B_{LNA}·Aⱼₐ·cos(2πfⱼₐt)

anti-phase: vⱼₐ_{_{—}}_{LNA-}=−vⱼₐ_{_{—}}_{LNA+} [Math. 4]

In the same manner, in [Math. 3], a transmission signal leakage component vₜₓ_{_{—}}_{LNA} (assuming that an in-phase component of the transmission signal leakage component is vₜₓ_{_{—}}_{LNA+}, and an anti-phase component of the transmission signal leakage component is vₜₓ_{_{—}}_{LNA-}) is calculated, in accordance with (Rₒ_{_{—}}_{LNA}//Rᵢ_{_{—}}_{MIX})A_{LNA}·a₁_{_{—}}_{LNA}·B_{LNA}·vₜₓ, by using [Math. 5].

in-phase: vₜₓ_{_{—}}_{LNA+}=(Rₒ_{_{—}}_{LNA}//Rᵢ_{_{—}}_{MIX})·A_{LNA}·a₁_{_{—}}_{LNA}·B_{LNA}·Aₜₓ·{1+m·cos(2πfₘt)}·cos(2πfⱼₐt)

anti-phase: vₜₓ_{_{—}}_{LNA-}=−vₜₓ_{_{—}}_{LNA+} [Math. 5]

A cross-modulation component v_{cm}_{_{—}}_{LNA} (assuming that an in-phase component of the cross-modulation component is v_{cm}_{_{—}}_{LNA+}, and an anti-phase component of the cross-modulation component is v_{cm}_{_{—}}_{LNA-}) is calculated, in accordance with 3(Rₒ_{_{—}}_{LNA}//Rᵢ_{_{—}}_{MIX})A_{LNA}·a₃_{_{—}}_{LNA}·B_{LNA}³·vⱼₐ·vₜₓ², by using [Math. 6].

$$in \text{-} phase \text{:} {v}_{cm\_LNA +} = \frac{3}{2} \cdot ( {R}_{o\_LNA} // {R}_{o\_MIX} ) \cdot {A}_{LNA} \cdot {a}_{3 \_LNA} \cdot {B}_{LNA}^{3} \cdot {A}_{ja} \cdot {A}_{tx}^{2} \cdot \{ 1 + m \cdot cos ( 2 π {f}_{m} t ) \} \cdot cos ( 2 π {f}_{ja} t ) \\ anti \text{-} phase \text{:} {v}_{cm\_LNA -} = - {v}_{cm\_LNA +} \qquad [ Math . 6 ]$$

Next, the down mixer 17 is described.

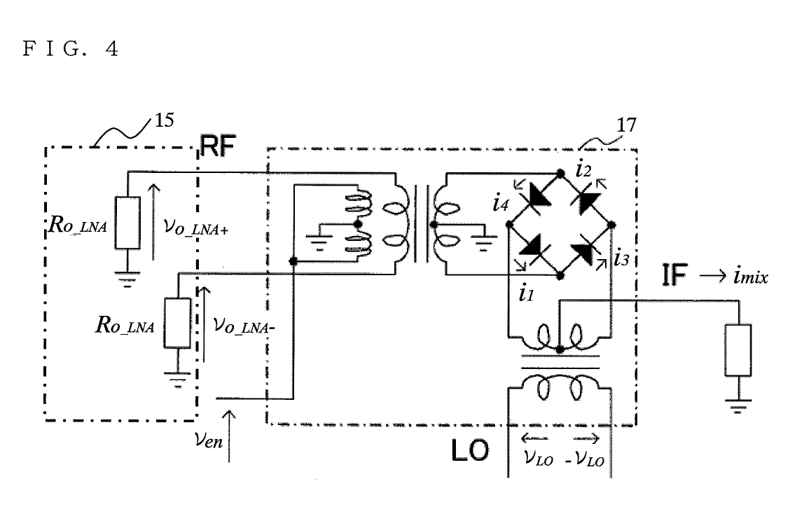

FIG. 4 illustrates an exemplary equivalent circuit model of the down mixer 17. It is assumed that the down mixer 17 is a double balanced mixer. A local signal v_{LO} (single side) is represented as [Math. 7]. Here, it is assumed that a local signal frequency is f_{LO}, and fⱼₐ<f_{LO} is satisfied.

v_{LO}=A_{LO}·cos(2πf_{LO}t) [Math. 7]

Further, the envelope signal vₑₙ to be injected is represented as [Math. 8].

vₑₙ=Aₑₙ·{1+m·cos(2πfₘt)}² [Math. 8]

Still further, an output current i_{MIX} with respect to an input voltage of the down mixer 17 is represented as [Math. 9]. f_{MIX}(x)=a₀_{_{—}}_{MIX}+a₁_{_{—}}_{MIX}x+a₂_{_{—}}_{MIX}x²+a₃_{_{—}}_{MIX}x³+a₄_{_{—MIX}}x⁴ (here, a₀_{_{—}}_{MIX}, a₁_{_{—}}_{MIX}, a₂_{_{—}}_{MIX}, and a₄_{_{—}}_{MIX} are constants) is satisfied.

i_{MIX}=A_{MIX}·(i₁+i₂−i₃−i₄)

∴i₁=f_{MIX} {B_{MIX}·(v_{LO}+vₒ_{_{—}}_{LNA+}+vₑₙ)}

i₂=f_{MIX} {B_{MIX}·(−v_{LO}+vₒ_{_{—}}_{LNA-}+vₑₙ)}

i₃=f_{MIX} {B_{MIX}·(v_{LO}+vₒ_{_{—}}_{LNA-}+vₑₙ)}

i₄=f_{MIX} {B_{MIX}·(−v_{LO}+vₒ_{_{—}}_{LNA+}+vₑₙ)} [Math. 9]

A cross-modulation component i_{cm}_{_{—}}_{MIX} is calculated, in accordance with 2A_{MIX}·a₂_{_{—}}_{MIX}·B_{MIX}·v_{cm}_{_{—}}_{LNA}+12A_{MIX}·a₄_{_{—}}_{MIX}·B_{MIX}⁴·v_{LO}·vⱼₐ_{_{—}}_{LNA}·vₜₓ_{_{—}}_{LNA}², by using [Math. 10].

$${i}_{cm\_MIX} = \{ 6 {a}_{2 \_MIX} \cdot {B}_{MIX}^{2} \cdot ( {R}_{o\_LNA} // {R}_{i\_MIX} ) \cdot {A}_{LNA} \cdot {a}_{3 \_LNA} \cdot {B}_{LNA}^{3} + 12 {a}_{4 \_MIX} \cdot {B}_{MIX}^{4} \cdot {( {R}_{o\_LNA} // {R}_{i\_MIX} )}^{3} \cdot {A}_{LNA}^{3} \cdot {a}_{1 \_LNA}^{3} \cdot {B}_{LNA}^{3} \} \cdot {A}_{MIX} \cdot {A}_{LO} \cdot {A}_{ja} \cdot {A}_{tx}^{2} \cdot {\{ 1 + m \cdot cos ( 2 π {f}_{m} t ) \}}^{2} \cdot cos \{ 2 π ( {f}_{LO} - {f}_{ja} ) \cdot t \} \qquad [ Math . 10 ]$$

A modulation component iₑₙ_{_{—}}_{MIX} of the envelope signal vₑₙ is calculated, in accordance with 6A_{MIX}·a₃_{_{—}}_{MIX}·B_{MIX}³·v_{LO}·vⱼₐ_{_{—LNA}}·vₑₙ, by using [Math. 11]. Note that the modulation component of the envelope signal in the fourth-order nonlinear term of the down mixer 17 is assumed to be negligible.

iₑₙ_{_{—}}_{MIX}=12a₃_{_{—}}_{MIX}·B_{MIX}³·(Rₒ_{_{—}}_{LNA}//Rᵢ_{_{—}}_{MIX})·A_{LNA}·a₁_{_{—}}_{LNA}·B_{LNA}·A_{MIX}·A_{LO}·Aⱼₐ·Aₑₙ·{1+m·cos(2πfₘt)}²·cos{2π(f_{LO}−fⱼₐ)·t} [Math. 11]

A condition of canceling the cross-modulation component i_{cm}_{_{—}}_{MIX} in [Math. 10] by the modulation component iₑₙ_{_{—}}_{MIX} of the envelope signal vₑₙ in [Math. 11] is represented as [Math. 12].

$${A}_{en} = - \frac{{B}_{LNA}^{2} \cdot {A}_{tx}^{2}}{2 {a}_{3 \_MIX} \cdot {B}_{MIX} \cdot {a}_{1 \_LNA}} \cdot \{ {a}_{2 \_MIX} \cdot {a}_{3 \_LNA} + 2 {a}_{4 \_MIX} \cdot {B}_{MIX}^{2} \cdot {( {R}_{o\_LNA} // {R}_{i\_MIX} )}^{2} \cdot {A}_{LNA}^{2} \cdot {a}_{1 \_LNA}^{3} \} \qquad [ Math . 12 ]$$

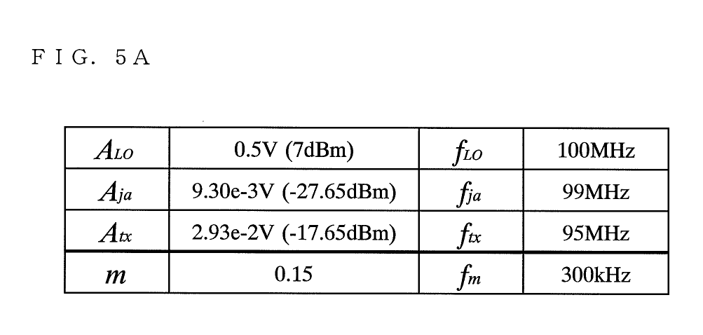

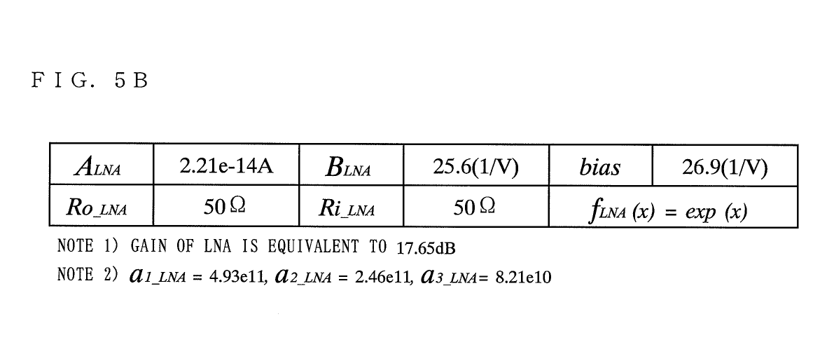

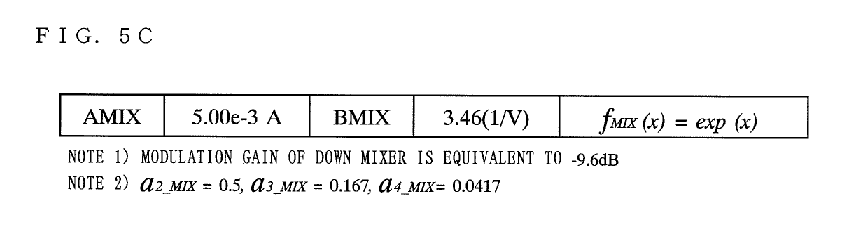

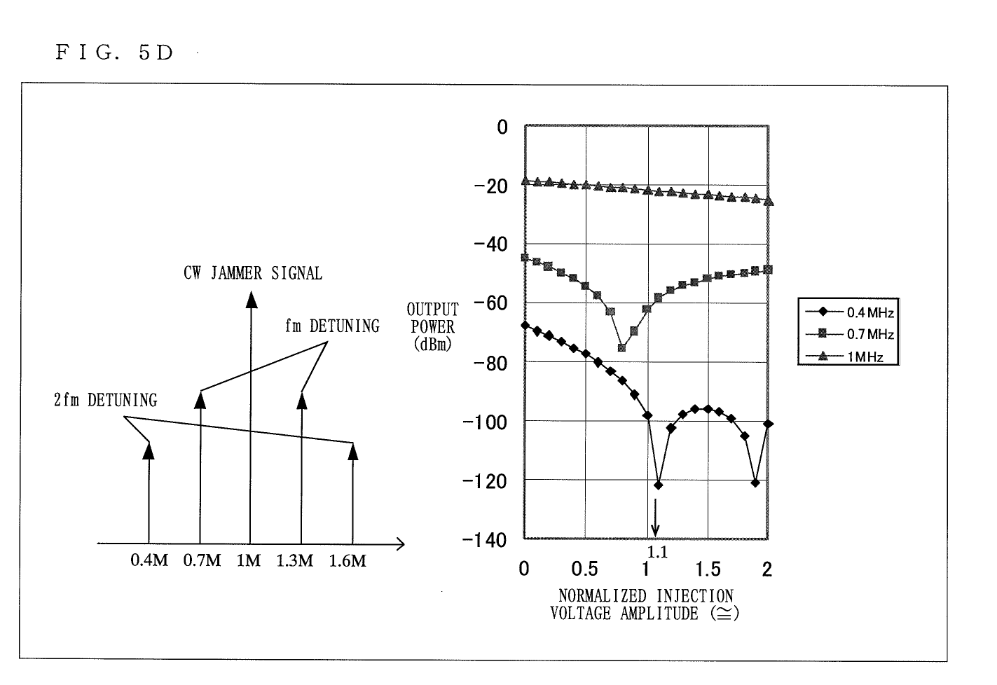

An output signal after the cross-modulation suppression can be calculated as a sum of i_{cm}_{_{—}}_{MIX} in [Math. 10] and iₑₙ_{_{—}}_{MIX} in [Math. 11]. Conditions of an input signal are as illustrated in FIG. 5A. Parameters of the LNA 15 are as illustrated in FIG. 5B. Parameters of the down mixer 17 are as illustrated in FIG. 5C. The envelope signal to be injected represented as [Math. 13] is used instead of that represented as [Math. 8]. Note that η denotes a normalized injection voltage amplitude.

vₑₙ=η·Aₑₙ·{1+m·cos(2πfₘt)}² [Math. 13]

FIG. 5D illustrates a calculation result of the sum of the cross-modulation component i_{cm}_{_{—}}_{MIX} and the modulation component iₑₙ_{_{—}}_{MIX}. A horizontal axis indicates η, and a vertical axis indicates an output power (value under 50Ω load). The output powers in the cases of f_{LO}-fⱼₐ-2fₘ (0.4 MHz), f_{LO}-fⱼₐ-fₘ (0.7 MHz), and f_{LO}-fⱼₐ (1 MHz), respectively, are illustrated. Thus, it can be seen that when η=0.8, the component in the case of fₘ detuning is suppressed by up to approximately 31 dB, and when η≈1.1, the component in the case of 2fₘ detuning becomes minimum and suppressed by up to approximately 54 dB.

The following two reasons may be reasons why η=1 is not satisfied. 1) Since a cross-modulation interference due to the transmission signal leakage based on a fourth or higher order component of the LNA and a fifth or higher order component of the down mixer exists, a local minimum value of η deviates from 1. 2) Due to an influence of a higher order component of the envelope signal to be injected, the higher order component being derived from a third or higher order component of the LNA and a fourth or higher order component of the down mixer, the local minimum value of η deviates from 1.

In this embodiment, when η=0.9, an fₘ detuning component can be reduced by 23 dB, and a 2fₘ detuning component can be reduced by 25 dB. FIG. 5D illustrates an exemplary case where only a voltage amplitude of the signal to be injected is controlled, but practically, it is necessary to control the delay time of the signal to be injected in consideration of a time period during which the transmission signal passes through the transmission RF circuit 13, the duplexer 14, and the LNA 15.

As described above, the radio circuit device according to the first embodiment of the present invention is capable of simultaneously reducing, by injecting in phase the envelope signals of the transmission signal leakage component into the inputs to the down mixer 17, the cross-modulation interferences occurring at the LNA 15 and the down mixer 17.

Although the AM modulated signal is used as the transmission signal in the first embodiment, any modulated signals having an envelope fluctuation, such as HPSK and OFDM, may be used.

### Second Embodiment

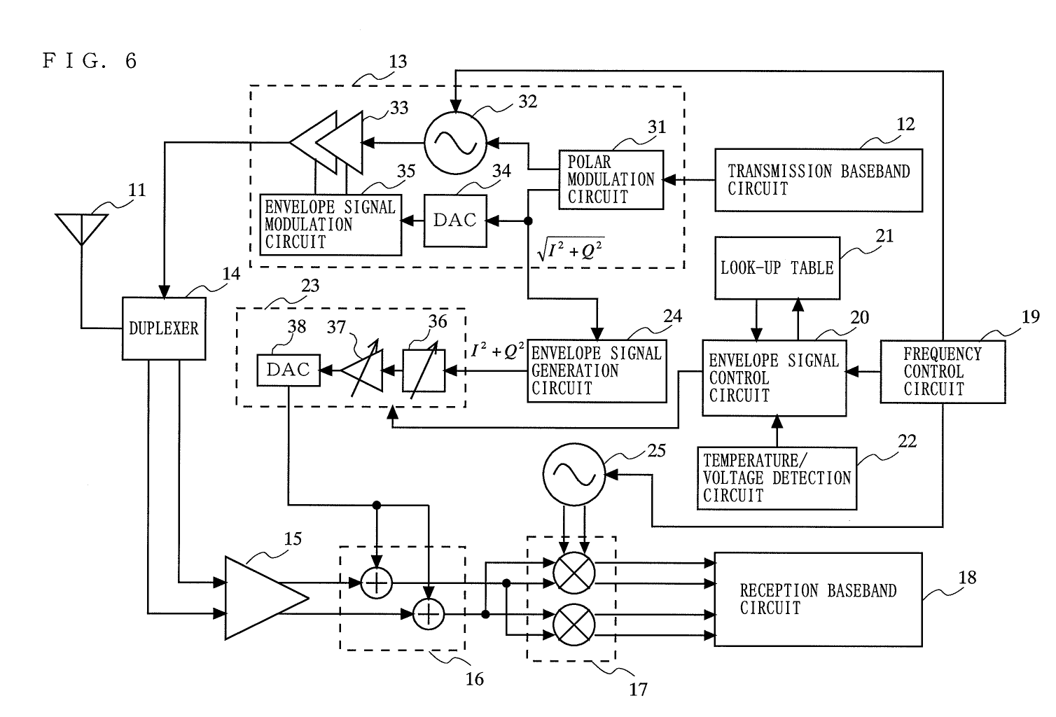

FIG. 6 is a diagram illustrating a configuration of a radio circuit device according to a second embodiment of the present invention. The radio circuit device according to the second embodiment uses polar modulation as architecture of a transmission RF circuit 13. In the polar modulation, a baseband signal includes a phase-modulated signal of a transmission signal and an absolute-value signal of an envelope of the transmission signal. Since an envelope signal generation circuit 24 simply squares the absolute value signal of the envelope generated by a transmission baseband circuit 12, the circuit can be compact.

In FIG. 6, the baseband signal outputted from the transmission baseband circuit 12 is separated by a polar modulation circuit 31 into a phase signal and an amplitude signal. The phase signal is converted to a phase-modulated signal by a phase modulator 32, and inputted to an amplifier 33. The amplitude signal is inputted to an envelope signal modulation circuit 35 via a digital-analog converter (DAC) 34, and modulated by the envelope signal modulation circuit 35 to a power supply signal for the amplifier 33. That is, the phase modulated signal generated by the phase modulator 32 is amplitude modulated by the power supply signal generated by the envelope signal modulation circuit 35, and a transmission signal from the amplifier 33 is outputted via a duplexer 14 from the antenna 11.

A desired signal and a GSM jammer signal which are received through the antenna 11, and a leaked transmission signal are converted by the duplexer 14 to differential signals, and the differential signals are amplified by the LNA 15, then converted by a down mixer 17 to the baseband signals by using locally generated signals generated by an oscillator 25, and inputted into a reception baseband circuit 18. A frequency control circuit 19 obtains, from channel information of a PLL circuit not shown in FIG. 6, information of a frequency of the transmission signal and a frequency of a reception signal, and controls the phase modulator 32 and the oscillator 25. The frequency control circuit 19 outputs a control signal to an envelope signal control circuit 20. The envelope signal generation circuit 24 generates, from the amplitude signal outputted from the polar modulation circuit 31, an envelope signal composed of a component of the square of an envelope of the amplitude signal. An envelope signal injection circuit 23 includes a phase shifter 36, a variable gain amplifier 37, and a DAC 38. The envelope signal injection circuit 23 corrects, in accordance with the control signal outputted by the envelope signal control circuit 20, at least one of an amplitude and a delay time of the envelope signal outputted from the envelope signal generation circuit 24, and injects the corrected in-phase envelope signal into each of the differential signals to be inputted into the down mixer 17. The envelope signal control circuit 20, a look-up table 21, and a temperature/voltage detection circuit 22 illustrated in FIG. 6 are the same in configuration as those illustrated in FIG. 1, and respective functions are the same as those described in the first embodiment.

As described above, the radio circuit device according to the second embodiment of the present invention is capable of simultaneously reducing, by injecting in phase the envelope signals of the transmission signal leakage component into the inputs to the down mixer 17, the cross-modulation interference occurring at the LNA 15 and the down mixer 17.

In a practical polar modulation transmission circuit, the absolute value signal of the envelope is further processed to enable distortion compensation. Accordingly, it is preferable that a signal inputted into the transmission baseband circuit 12 is a signal which has not been subjected to distortion compensation processing.

### Third Embodiment

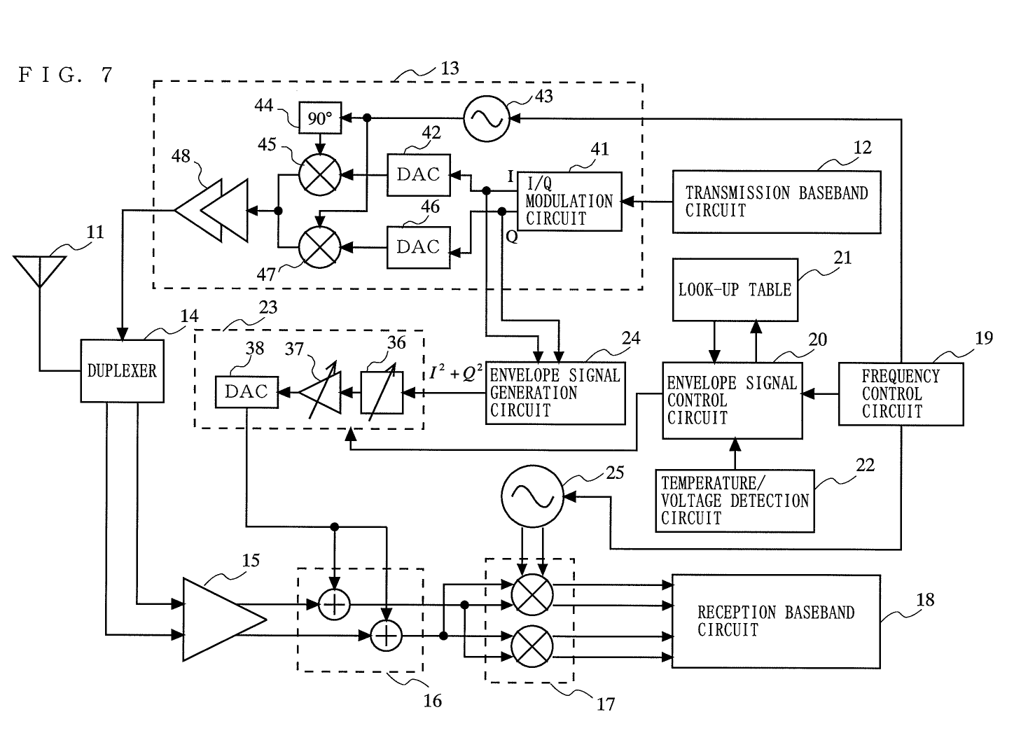

FIG. 7 is a diagram illustrating a configuration of a radio circuit device according to a third embodiment of the present invention. The radio circuit device according to the third embodiment uses orthogonal modulation as architecture of a transmission RF circuit 13.

In FIG. 7, a baseband signal outputted from a transmission baseband circuit 12 is separated by an I/Q modulation circuit 41 into an I component and a Q component, which are orthogonal to each other. The I component signal is sent to a DAC 42 and the Q component signal is sent to a DAC 46. Outputs from the DAC 42 and DAC 46 are modulated by multipliers 45 and 47, respectively, into an RF transmission signal based on a carrier generated by an oscillator 43. At this time, to either one of the multipliers 45 and 47, the carrier generated by the oscillator 43 is inputted via a 90 degree phase shifter 44. The RF transmission signal is amplified by an amplifier 48 and outputted via a duplexer 14 from an antenna 11.

A desired signal and a GSM jammer signal which are received through the antenna 11, and a leaked transmission signal are converted by the duplexer 14 to differential signals, and the differential signals are amplified by the LNA 15, then converted by a down mixer 17 to the baseband signals by using locally generated signals generated by an oscillator 25, and inputted into a reception baseband circuit 18. A frequency control circuit 19 obtains, from channel information of a PLL circuit not shown in FIG. 7, information of a frequency of the transmission signal and a frequency of a reception signal, and controls the oscillators 43 and 25. The frequency control circuit 19 outputs a control signal to an envelope signal control circuit 20. The envelope signal generation circuit 24 generates, from the I component signal and the Q component signal outputted by the I/Q modulation circuit 41, an envelope signal composed of a component of the square of an envelop of each signal. An envelope signal injection circuit 23 includes a phase shifter 36, a variable gain amplifier 37, and a DAC 38. The envelope signal injection circuit 23 corrects, in accordance with the control signal outputted by the envelope signal control circuit 20, an amplitude and a delay time of the envelope signal outputted from the envelope signal generation circuit 24, and injects the corrected in-phase envelope signal into each of the differential signals to be inputted into the down mixer 17. The envelope signal control circuit 20, a look-up table 21, and a temperature/voltage detection circuit 22 illustrated in FIG. 7 are the same in configuration as those illustrated in FIG. 1, and respective functions are as described in the first embodiment.

As described above, the radio circuit device according to the third embodiment of the present invention is capable of simultaneously reducing, by injecting in phase the envelope signals of the transmission signal leakage component into the inputs to the down mixer 17, the cross-modulation interference occurring at the LNA 15 and the down mixer 17.

### Fourth Embodiment

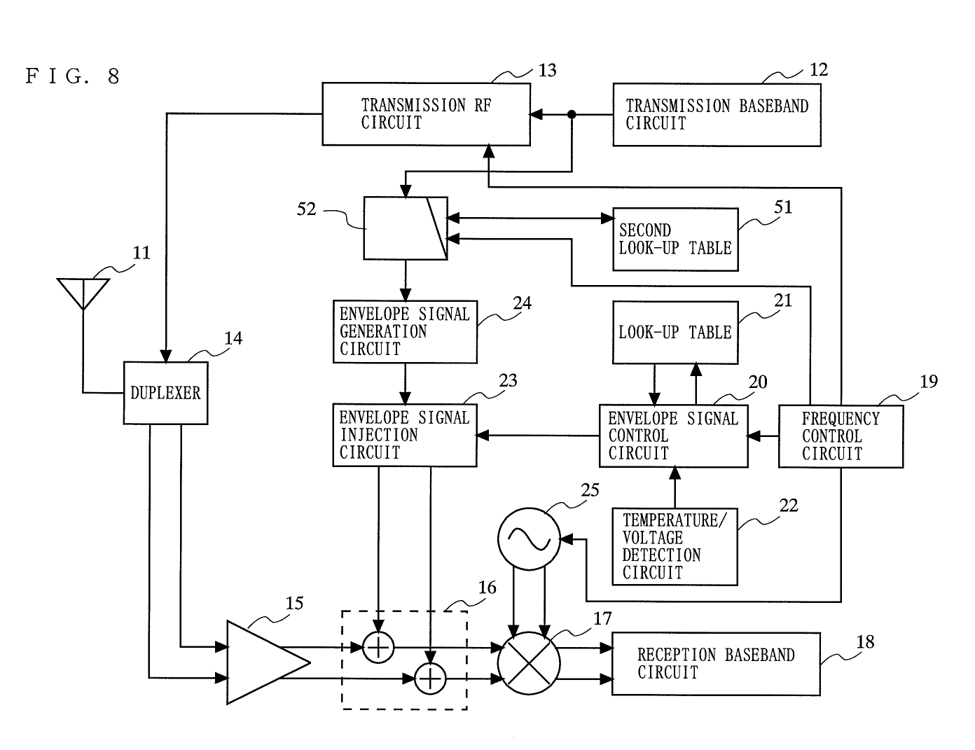

FIG. 8 is a diagram illustrating a configuration of a radio circuit device according to a fourth embodiment of the present invention. The radio circuit device according to the fourth embodiment and the radio circuit device according to the first embodiment have the same configuration except that the radio circuit device according to the present embodiment includes a second look-up table 51 and a variable filter circuit 52. The variable filter circuit 52 is, for example, a digital filter circuit.

A transmission signal which leaks to a reception circuit passes through a duplexer 14. An attenuation amount in the transmission signal at the duplexer 14 is frequency-dependent. Accordingly, a spectrum of an envelope of the transmission signal which leaks to the reception circuit becomes a spectrum in which a frequency response of the duplexer 14 is superimposed on the original transmission signal. Consequently, the frequency response of the duplexer 14 is required to be superimposed on each of envelope signals which are to be injected into differential signals to be inputted to a down mixer 17.

In FIG. 8, the variable filter circuit 52 is provided preceding an envelope signal generation circuit 24. In the second look-up table 51, frequency response information of the duplexer 14 at each transmission frequency is previously stored as illustrated in FIG. 10, for example. The variable filter circuit 52 refers to the frequency response information stored in the second look-up table 51, and varies a filter characteristic (filter coefficient). Specifically, a control is performed such that an amplitude-frequency characteristic of an envelope signal of the transmission signal which has passed through the variable filter circuit 52 becomes substantially equal to an amplitude-frequency characteristic of the transmission signal which leaks to the reception circuit. Accordingly, even when the attenuation amount in the transmission signal at the duplexer 14 is frequency-dependent, cross-modulation noise can be reduced.

### Fifth Embodiment

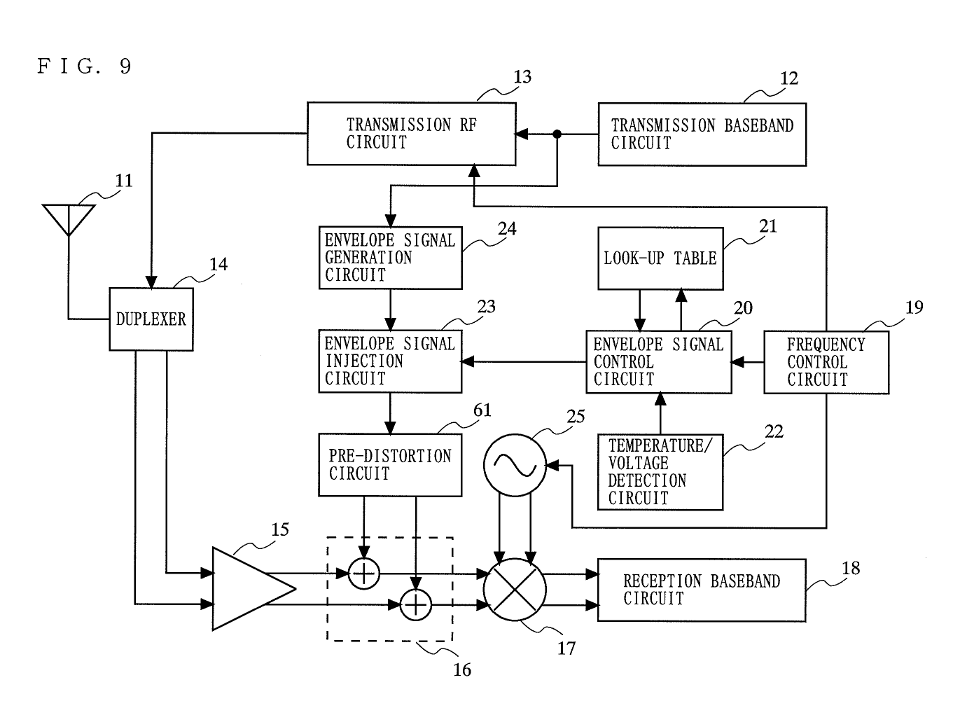

FIG. 9 is a diagram illustrating a configuration of a radio circuit device according to a fifth embodiment of the present invention. The radio circuit device according to the fifth embodiment and the radio circuit device according to the first embodiment have the same configuration except that the radio circuit device according to the fifth embodiment includes a pre-distortion circuit 61. The pre-distortion circuit 61 distorts an envelope signal outputted from an envelope signal injection circuit 23 and provides the resultant to an adder 16.

As illustrated in FIG. 2, a phase of an fₘ component of an AM-modulated envelope signal coincides with a phase of a 2fₘ component of the AM-modulated envelope signal. Accordingly, assuming that fₘ=1 MHz, for example, suppression amounts of a 1 MHz component and a 2 MHz component are expected to become maximum by approximately the same delay amount. However, a simulation performed by the inventors of the present application indicates a result that the delay amount by which the suppression amount of the 1 MHz component becomes maximum is different from the delay amount by which the suppression amount of the 2 MHz component becomes maximum. Such difference may be caused by a difference between a phase of a nonlinear coefficient which is a factor for the cross-modulation of the transmission signal, and a phase of a nonlinear coefficient enabling reduction of the cross-modulation by use of the envelope signal.

Accordingly, in order to maximally reduce a noise level of the cross-modulation in each of the fₘ component and the 2fₘ component of the inputted envelope signal by approximately the same delay time, a phase difference is required to be produced between the fₘ component and the 2fₘ component of the envelope signal to be inputted. The pre-distortion circuit 61 has a function to produce the phase difference between the fₘ component and the 2fₘ component. The pre-distortion circuit 61 may be replaced with a delay time change circuit which is capable of adjusting any delay time by changing a combination of delay elements selected from a plurality of delay elements.

### INDUSTRIAL APPLICABILITY

The radio circuit device of the present invention is applicable to a radio circuit section or the like of a radio communication device under IS-95, UMTS (W-CDMA), or 3G LTE, in which a transmission signal has an amplitude fluctuation and in which simultaneous transmission and reception is performed. The radio circuit device of the present invention is useful, for example, for reducing a cross-modulation interference that occurs at a reception circuit due to a transmission signal leakage.

1. A radio circuit device comprising a duplexer for separating between transmission and reception, the radio circuit device comprising:
a transmission baseband circuit for outputting a transmission signal;
a reception circuit for receiving, via the duplexer, a reception signal having been converted to differential signals;
an envelope signal generation circuit for generating, from the transmission signal outputted by the transmission baseband circuit, an envelope signal derived from a component of a square of an envelope of the transmission signal;
an envelope signal control circuit for outputting a control signal to control at least one of an amplitude of the envelope signal, and a delay time of the envelope signal with respect to the transmission signal; and
an envelope signal injection circuit for correcting, in accordance with the control signal outputted by the envelope signal control circuit, at least one of the amplitude and the delay time of the envelope signal, for injecting in phase the corrected envelope signal into each of the differential signals to be inputted to the reception circuit; and for controlling at least one of the amplitude and the delay time of the envelope signal such that an amplitude of an addition signal becomes substantially zero, to suppress a differential component of the cross modulated signal generated from a received jammer signal and a leaked transmission signal having leaked to the reception circuit via the duplexer, wherein the addition signal is obtained by adding a signal generated by cross-modulation between the received jammer signal and the leaked transmission signal having leaked to the reception circuit via the duplexer due to nonlinearity represented by a low noise amplifier and a down mixer, to a signal generated by up-converting the corrected envelope signal to the received jammer signal due to nonlinearity of the low noise amplifier and the down mixer.

2. (canceled)

3. The radio circuit device according to claim 1, further comprising a look-up table for storing information indicating a relationship between the amplitude and the delay time of the envelope signal, wherein
the envelope signal control circuit outputs the control signal in accordance with the information stored in the look-up table.

4. The radio circuit device according to claim 3, wherein
the look-up table stores the information indicating the relationship between the amplitude and the delay time of the envelope signal for each transmission frequency, and
the envelope signal control circuit outputs the control signal in accordance with a frequency of the transmission signal.

5. The radio circuit device according to claim 3, wherein
the look-up table stores the information indicating the relationship between the amplitude and the delay time of the envelope signal for each reception frequency, and
the envelope signal control circuit outputs the control signal in accordance with a frequency of the reception signal.

6. The radio circuit device according to claim 3, wherein
the look-up table stores the information indicating the relationship between the amplitude and the delay time of the envelope signal for each power supply voltage supplied to the radio circuit device, and
the envelope signal control circuit outputs the control signal in accordance with the power supply voltage.

7. The radio circuit device according to claim 3, wherein
the look-up table stores information indicating the relationship between the amplitude and the delay time of the envelope signal for each temperature within the radio circuit device, and
the envelope signal control circuit outputs the control signal in accordance with the temperature.

8. The radio circuit device according to claim 1, wherein
the reception circuit includes an amplifier for amplifying the differential signals, and a down mixer for converting the differential signals which have been amplified by the amplifier to baseband signals by using locally generated signals, and
the envelope signal injection circuit injects the corrected envelope signals into inputs, respectively, to the down mixer in the reception circuit.

9. The radio circuit device according to claim 1, wherein
the reception circuit includes an amplifier for amplifying the differential signals, and a down mixer for converting the differential signals which have been amplified by the amplifier to baseband signals by using locally generated signals, and
the envelope signal injection circuit injects the corrected envelope signals into inputs, respectively, to the amplifier in the reception circuit.

10. The radio circuit device according to claim 1, wherein
the transmission baseband circuit outputs a baseband signal modulated by polar modulation, and
the envelope signal generation circuit generates the envelope signal based on a square of an amplitude modulated signal included in the baseband signal.

11. The radio circuit device according to claim 1, wherein the transmission baseband circuit outputs a baseband signal modulated by orthogonal modulation, and
the envelope signal generation circuit generates the envelope signal based on a sum of a square of an I component signal and a Q component signal of the baseband signal.

12. The radio circuit device according to claim 1, further comprising a digital filter circuit provided preceding the envelope signal generation circuit, wherein
a filter coefficient of the digital filter circuit is controlled such that a frequency characteristic of the envelope signal which passes through the digital filter circuit becomes substantially equal to a frequency characteristic of an amplitude of the leaked transmission signal.

13. The radio circuit device according to claim 1, further comprising a pre-distortion circuit provided between the envelope signal control circuit and the reception circuit, for distorting the envelope signal outputted by the envelope signal injection circuit.

14. The radio circuit device according to claim 1, further comprising a delay time change circuit provided between the envelope signal control circuit and the reception circuit, for adjusting any delay time by changing a combination of delay elements selected from a plurality of delay elements.
